(19) United States
(12) Patent Application Publication
(10) Pub. No.: US 2006/0078654 A1
(43) Pub. Date: Apr. 13, 2006

(54) Package for a consumable product or the like

(76) Inventors: Katie Johanna Kushner, Chicago, IL (US); Donald Melvin Deck, Boilingbrook, IL (US); Joseph Rancich, Park Ridge, IL (US)

Correspondence Address: Bell, Boyd & Lloyd LLC, P.O. Box 1135, Chicago, IL, 60690-1135, US

(21) Appl. No.: 10/961,965

(22) Filed: Oct. 8, 2004

(51) Int. Cl. A23B 7/148

(52) U.S. Cl. 426/106

(57) ABSTRACT

The present invention provides an improved product holding and dispensing package and an improved method for providing, holding and storing products, especially consumable products. The package includes a housing, a product insert and a wrapper that initially seals the outside of the housing. The housing includes an opening that enables a consumer to remove and reinsert the insert from and into the housing. When the consumer removes the insert from the housing, the consumer can remove one or more products from the insert. A compartment that holds the one or more removed products is constructed to hold its shape even after the product is removed so that the insert as a whole maintains its shape even when the insert is partially or substantially empty. The insert in a preferred embodiment slightly press-fits or biases against a number of the walls of the housing.

### BACKGROUND OF THE INVENTION

The present invention relates generally to packaging. More particularly, the present invention relates to packaging for storing and dispensing consumable products.

The packaging for consumable or confectionery products is very important to the look, marketing and storage of the product. Very often, in addition to text on the packaging, the packaging also attempts to visually convey a message about the type of product, the taste of the product or the purpose of the product. For example, packages for cinnamon or cherry tasting products are often red, grape tasting product packaging is often purple, etc. Once the consumer has identified a desired brand, the consumer can typically choose a product based solely on the color of the packaging.

In marketing the product, packaging can convey other information besides taste. For example, certain recent gum products have been developed that have an increased minty taste and that also whiten teeth and freshen breath. The packaging for these products can be made to look like a known tooth paste housing. The consumer can thereby associate the product with its effect by simply viewing the packaging.

There are also practical facets to packaging consumable products, namely, keeping the products from being damaged during shipping, keeping the products fresh, and in certain instances providing a reusable package. Some consumable products do not require that the packaging be robust, sturdy or reusable. For example, candy bars are typically eaten in a single sitting and do not require a reusable package. Candy bars therefore tend to be packaged in thin wrappers that the consumer tears open and discards.

Other consumable products are packaged in pieces and may or may not be provided in a reusable package, as desired by the manufacturer. If it is felt that only a portion of the products may be consumed in one sitting, the manufacturer may wish to provide a box having a hingedly connected lid.

Gum products are typically individually packaged in a wrapper. When the consumer desires one of the gum products, the consumer tears open the package and removes a stick or piece of gum. While known gum wrappers are adequate for most types of gum, the gum manufacturer in certain situations desires to provide a more sterile and sealed environment for the gum products.

Known gum wrappers somewhat protect the gum from ambient conditions, but they are not airtight. Also, as the consumer removes pieces from typical wrappers, the wrappers lose integrity and deform. If, for example, the gum is heated, e.g., exposed to the sun, known wrappers do not offer significant protection if the consumer sits on the gum or otherwise applies pressure to the gum package.

It is therefore desirable to provide a product package that maintains the products in an airtight or semi-airtight compartment to preserve the products and increase shelf-life.

It is also desirable to provide products in a package that is not costly but that is robust enough not to deform when less than all the products are removed from the package.

### SUMMARY OF THE INVENTION

The present invention provides an improved product holding and dispensing package and an improved method for providing, holding and storing products, especially consumable products. More specifically, the present invention provides a package or dispenser that includes multiple compartments for storing different types, shapes, sizes, colors and/or flavors of confectionery products. The containers in one preferred embodiment include a plastic component and a paperboard component. As discussed in detail below, the embodiments vary as to which parts of the dispensers are plastic and which parts of the dispensers are paperboard. In any case, the multiple compartments enable the consumer to mix and match different types, shapes, colors and/or flavors of confectionery products from different compartments simultaneously. Alternatively, the multi-compartment confectionery product dispenser enables the consumer to dispense products from one compartment completely, while maintaining products in one or more other compartments in a fresh or unopened condition. To that end, each of the compartments can be provided with a separate tamper-resist strip that ensures that the compartment has not been opened previously.

In one embodiment, the package includes a paperboard housing, paperboard inserts defining inner walls, and a plastic top. The plastic top includes multiple doors or accessways that enable the consumer to selectively dispense confectionery products from the compartments. The housing and top can be rectangular, angled, ovular, circular, rounded or any combination thereof. The lids or accessways in one embodiment are hingedly connected to the plastic top and can open in a variety of directions. The packages can include any suitable number of separate compartments, such as two to four compartments, which can hold a like number of different products.

In another embodiment, the dispensers include a plastic top, a plastic bottom, a paperboard outer wrapper and a paperboard insert. This configuration can also be made in multiple different types of shapes, have any suitable number of compartments and be provided with lids that hinge open in one of the same or different directions. In any of the embodiments described herein, the compartments can be sized the same or differently.

In another embodiment, the top, bottom and separating-walls are each plastic and perhaps part of a single plastic frame. A paperboard wrapper or shell is then wrapped about and adhered or press-fit to the plastic frame. The plastic frame embodiment can define any suitable angled or rounded shape, have any suitable number of compartments and have any suitable hinge arrangement.

In a further alternative embodiment, the front, back, sides, bottom and separating walls are made of a single piece of paperboard that is folded multiple times and press-fit or adhered together. A plastic top defining or including a number of lids or accessways is then adhered or press-fit to the cardboard housing.

In still another alternative embodiment, the dispenser includes a paperboard housing having a front, back, sides and bottom, wherein the housing receives a separate paperboard insert. The paperboard insert defines multiple compartments within the housing. A plastic top is then press-fit or adhered to one or both the insert and the housing. In one embodiment, the insert is also adhered or press-fit inside the housing. As discussed above, each of the embodiments described herein can be substantially rectangular, substantially rounded or have any suitable shape. The lids enclosing the multiple compartments can open in different directions to provide a fun and interesting package that is tilted in different directions to dispense different products. Further, the lids can open or hinge from the same surface or side of the dispenser or open or hinge from one or more different sides or surfaces of the dispenser.

It is therefore an advantage of the present invention is to provide an improved package for confectionary products.

Another advantage of the present invention is to provide an improved package for consumable products, which maintains product freshness.

A further advantage of the present invention is to provide a package or dispenser that dispenses multiple different types, shapes, colors, flavors and/or sizes of confectionery products.

It is another advantage of the present invention to provide a multi-product dispensing apparatus that is economically constructed.

Moreover, it is an advantage of the present invention to provide a unique method of dispensing confectionery products.

Still further, it is an advantage of the present invention to provide a confectionery product dispenser that enables the consumer to dispense products from one compartment before dispensing products from another compartment and thereby maintain the freshness of the products of the unopened compartment.

Further still, it is an advantage of the present invention to provide a multi- compartment product dispenser that enables the consumer to mix and match different types, shapes, colors and/or flavors of confectionery product to produce a unique overall consumable item as desired by the consumer.

Additional features and advantages of the present invention will be described in and apparent from the detailed description of the presently preferred embodiments.

### BRIEF DESCRIPTION OF THE FIGURES

FIGS. 1 and 2 are perspective views of different embodiments of the confectionery product dispenser of the present invention having a paperboard housing, paperboard separating walls and a plastic top.

FIGS. 3 and 4 are exploded perspective views of various embodiments of the confectionery product dispenser of the present invention having a plastic top, a plastic bottom, a paperboard separating wall insert and a paperboard outer wrapper.

FIG. 5 is an exploded perspective view of one embodiment of the confectionery product dispenser of the present invention having a plastic frame including a plastic top, plastic bottom and plastic separating walls, which is surrounded by a paperboard wrapper.

FIG. 6 is an exploded perspective view of one embodiment of the confectionery product dispenser of the present invention having a housing and insert made from one piece of paperboard, which is attached to a plastic top.

FIGS. 7 and 8 are perspective views of multiple embodiments of the confectionery product dispenser of the present invention, which include a paperboard housing, a separate paperboard insert and plastic tops.

FIGS. 9 and 10 are perspective views of multiple embodiments of the confectionery product dispenser of the present invention, which each include a plastic frame including a plastic top, plastic bottom and a plastic separating wall, and which each provide openings or accesses on different surfaces of the dispensers.

### DETAILED DESCRIPTION OF THE PRESENTLY PREFERRED EMBODIMENTS

The present invention provides an improved confectionary product dispenser. The dispenser or container is made of different materials such as paperboard and plastic. The container also includes separating walls that divide the container into a plurality of compartments. The container provides a separate accessway for each compartment. The container can therefore hold different types of confectionary products, such as gum, candy or mints. The container can hold different colors of the same or different confectionary product. Differently flavored, coated or textured products can also be stored in the different compartments.

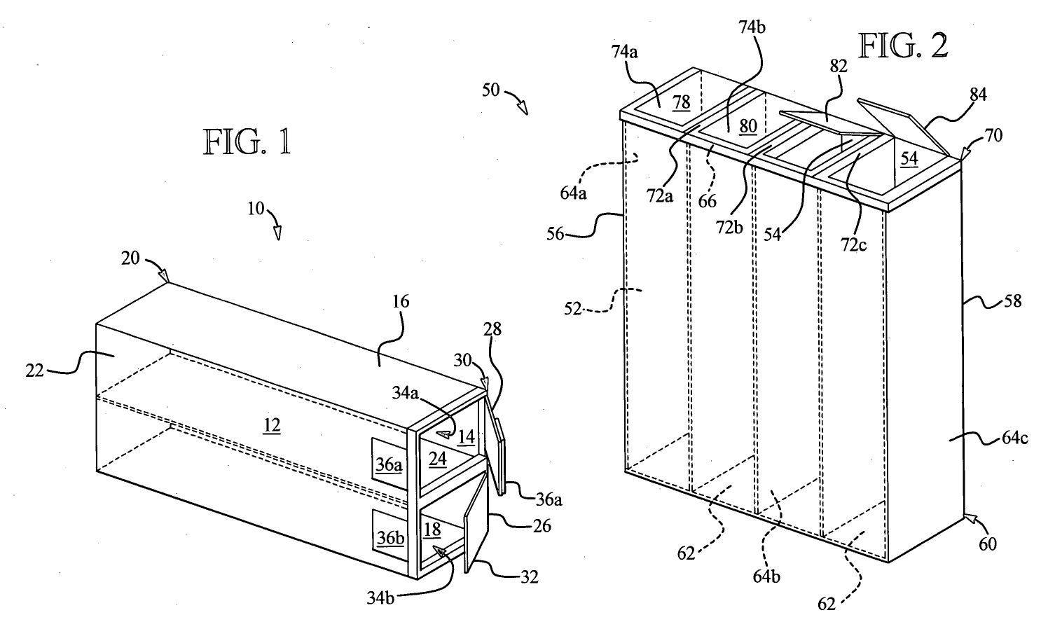

Referring now to the drawings and in particular to FIG. 1, one embodiment of the confectionary container of the present invention is illustrated by container 10.

Container 10 includes a housing 20. Housing 20 includes a front 12, a back 14, sides 16 and 18 and a bottom 22. Housing 20 is made of a first material, such as paperboard. The term paperboard as used herein refers to any type of paper product, such as paper of any suitable grade or type, cardboard or poster board. The paperboard can be of any suitable texture, grade, color and thickness. The paperboard can be multi-colored or otherwise provided with suitable nutritional, ingredient, marking and branding indicia as desired.

A separating wall 24 is also provided within housing 20. In one embodiment, separating wall 24 is made of the same paperboard material as the remainder of housing 20. Alternatively, separating wall 24 may be made of a different type of paperboard or may be plastic as shown in more detail below.

Separating wall 24 divides housing 20 into two compartments 34a and 34b. Compartments 34a and 34b hold confectionary products of different types, such as gum, candy or mints. Compartments 34 hold the same or different confectionary product having a different color, texture and/or different flavor. The different compartments enable the user to select the desired color or type of confectionary product to consume. Separate compartments 34a and 34b also enable the consumer to remove and consume confectionary products from one of the compartments 34a or 34b, while maintaining the confectionary products in the other compartment 34a or 34b in a fresh, unopened and sealed state. To that end, tamper resist strips 36a and 36b are provided on front 12 and hinged lids 28 and 32, respectively.

The separate tamper-resist strips 36a and 36b enable the consumer to keep one compartment 34a or 34b sealed and break or tear the other tamper-resist strip 36a or 36b to remove products from the associated compartment 34a or 34b. It should be appreciated that while the packages or containers of FIGS. 2 through 8 do not show tamper-resist strips, any of those embodiments can employ one or more such strips that each seal individual ones of the compartments or seal multiple ones of the compartments.

A formed plastic top 30 is fixed to the edges of front 12, sides 16 and 18, back 14 as well as separating wall 24. Plastic top 30 can be made of any suitable polymer or synthetic material, such as acrylic, bakelite, butyrate, cellulose acetate, CPVC, CTFE, delrin, garolite, Kel-F, kynar, nylon, phenolic, polyimide, polycarbonate, polyester, polyethylene, polypropylene, polystyrene, polyvinyl chloride (“PVC”), PVDF, ULTEM, any high or low weight version of the listed plastics and any combination or derivative thereof. In one embodiment, top 30 is translucent or transparent, so that the consumer can view the type and amount of products residing within compartments 34a and 34b. The translucent or transparent top 30 can also be tinted or have a color. Alternatively, the top 30 is colored and opaque or substantially opaque. Top 30 can also have or provide any of the above-described indicia.

Top 30 is fixed to housing 20 via a press-fit, a suitable adhesive, or a combination of those methods. As shown below top 30 can also include flanges that extend into the compartments, such as compartments 34a and 34b of housing 20, to aid in adhering or press-fitting top 30 and housing 20.

As illustrated, lids or doors 28 and 32 are connected hingedly to top 30. Doors 28 and 32 in one embodiment snap-fit or click closed to top 30. As illustrated, doors 28 and 32 are in one embodiment hinged along the same side of top 30. Alternatively, lids 28 and 32 are hinged along opposite sides of top 30 or along a divider 26 that is coupled to separating wall 24. Lids 28 and 32 may each be hinged along front 12, back 14, sides 16 or 18, divider 26 or any combination thereof.

Referring now to FIG. 2, a second embodiment of the package or container of the present invention is illustrated by package 50. Package 50 and package 10 show that the packages or containers of the present invention can have any suitable number of compartments. Package 52 includes a front 52, a back 54, sides 56 and 58 and a bottom 62. Those components along with separating walls 64a to 64c are made of paperboard and together form housing 60. Housing 60 is attached to a plastic top 70 via any of the methods and apparatuses described above in connection with package or container 10.

Top 70 includes or defines dividers 72a, 72b and 72c. Those plastic dividers are coupled to paperboard dividing walls 64a to 64c adhesively and/or via a press-fit relationship as described above in connection with container 10. Doors or lids 78, 80, 82 and 84 are each individually hinged to one of the outer frame members of top 70. The hinged connection can have any of the configurations described above in connection with package 10. That is, doors or lids 78, 80, 82 and 84 can each open (i) in the same direction, (ii) in opposite directions, (iii) from any of the bordering sides of lid 70 or (iv) from dividers 72a through 72c. As described below, doors or lids may also may be provided on and open from different sides or surfaces of the dispensers.

Housing 60 and top 70 together form four separate closed volume compartments 74a to 74d. Separate compartments 74a to 74d can each receive different types of confectionary products, colors of confectionary products, flavors of confectionary products, etc., or any combination thereof. The consumer can mix and match at least four different types, colors or flavors, etc., of confectionary products to form a unique overall product as desired by the consumer. Alternatively, the consumer can consume products from one or more compartments 74a to 74d and at the same time leave products in other compartments sealed and in a fresh, unused state. To that end, as illustrated in FIG. 1, package 50 provides one or more tear strips 36 (referring collectively to each of the tear strips), so that the unused products from the unopened compartments 74a to 74d remain sealed and fresh.

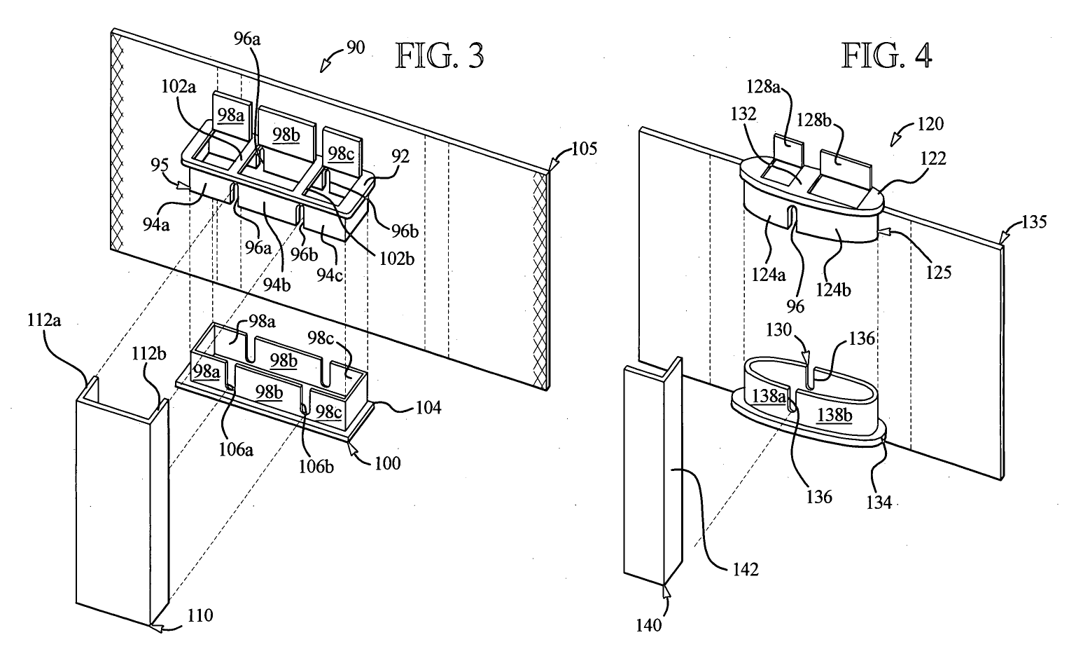

Referring now to FIG. 3, an alternative embodiment for the package or container of the present invention is illustrated by package 90, which is shown in an exploded view. Package 90 includes four main components, including a plastic top 95, a plastic bottom 100, a paperboard cover or shell 105 and a paperboard insert or separator 110.

The plastic top 95 and plastic bottom 100 are made of any of the types of plastics described above. The plastic top 95 includes a frame 92 as well as flange portions 94a, 94b and 94c. Flange portions 94a to 94c are separated or defined by notches 96a and 96b. Notches 96a and 96b are sized to receive separating walls 112a and 112b of insert 110.

As illustrated, top 95 includes three doors or lids 98a to 98c, which are individually hinged to frame portion 92 of top 95. While lids 98a to 98c are shown each hingedly connected to a same side of frame 92, the doors can be hinged in any of the arrangements or configurations described above. Lids 98a to 98c are separated by dividers 102a and 102b, which are in substantial alignment with notches 96a and 96b.

As illustrated, notches 96a and 96b are provided on two sides of top 95, so that separating walls 112a and 112b extend into the thicknesses of flanges 94a to 94c and abut against the inner surface of wrapper 105. At least some of the notches 96a and 96b in an embodiment provide a slight press-fit against separating walls 112a and 112b. In that manner, the assembly of plastic portions 95 and 100 to insert 110 is held in place temporarily until cover 105 is secured around the assembly.

Flange portions 94a to 94c provide additional areas upon which to adhere and/or press-fit wrapper 105 to dispenser 90. A suitable adhesive can be applied either to one or both flange portions 94a to 94c and wrapper 105 to connect the wrapper to the flange portions. The underside of frame 92 of top 95 may also receive adhesive and/or provide press-fitting grooves to receive cover 105.

Bottom 100 has substantially the same overall shape as top 95. Indeed, bottom 100 and top 95 may be made from the same mold or substantially similar molds. Bottom 100 includes a frame 104 as well as notches 106a and 106b that separate flange portions 98a to 98c. Notches 106a and 106b are aligned with notches 96a and 96b. Notches 106a and 106b are made in both and front sides of bottom 100, so that the bottom portion of separating walls 112 and 112b extends all the way through bottom 100 to contact cover 105. Again, a suitable adhesive and/or press-fit is provided by flanges 98a to 98c and frame 104 to hold insert 110 in place as well as to provide a contacting area to hold and cover 105.

Cover 105 and insert 110 are in one embodiment made of paperboard. Dotted fold lines are provided on cover 105, which is shown on a flat. The dotted lines mark the points on cover 105 at which the cover is bent to secure to top 95 and bottom 100. Cover 105 can be adhered to any one or all of the top 95, bottom 100 and insert 110 and to multiple parts of each. Cover 105 is relatively sturdy so as to provide a suitable outer packaging material.

It should be appreciated that any of the embodiments of the packages or dispensers described herein can be packaged with a cellophane or other outer packaging or wrapping material. The outer wrapper provides additional safety, tamper-resist and product freshness support. Further, cover 105 as well as the outside of any of the packages described herein includes branding, marking and/or ingredient indicia and any other suitable product information.

Package or dispenser 90 illustrates that in any of the embodiments described herein, the hinged lids and associated compartments can be of the same or different size. The compartments of the packages of the present invention thereby can hold different amounts of different confectionary products.

Referring now to FIG. 4, a further alternatively embodiment of the package or dispenser of the present invention is illustrated by package or dispenser 120. Package or dispenser 120 includes the same primary components as package 90, namely a plastic top 125, a plastic bottom 130, a paperboard cover or outer shell 135 and an insert 140 that includes or defines a separating wall 142.

Plastic top 125 includes or defines a frame 122 and flange portions 124a and 124b extending downwardly from frame 122. Flange portions 124a and 124b define a notch 96, which extends through both sides of top 125 so that separating wall 142 may extend the entire way through top 125 and abut, press-fit and/or adhere to cover 135.

Top 125 includes or defines doors or lids 128a and 128b that are attached hingedly to frame 122. A divider 132 of frame 122 separates doors 128a and 128b. Doors 128a and 128b are hingedly attached to the same or different sides of top 125 or to divider 132. Doors 128a and 128b open and snap close as is the case with the other embodiments described herein.

Plastic bottom 130 includes a bottom frame 134 and upperwardly extending flange portions 138a and 138b. The flange portions 138a and 138b are separated by a notch 136. Notch 136 is aligned with notch 96 to receive separating wall 142 of insert 140. Cover 135 is fixed to any one or more of top 125, bottom 130 and/or insert 140 via any of the techniques described in connection with dispenser 90 of FIG. 3. Dispenser 120 illustrates that a dispenser of the present invention can have a rounded or oval shape as opposed to or in addition to a square or rectangular shape.

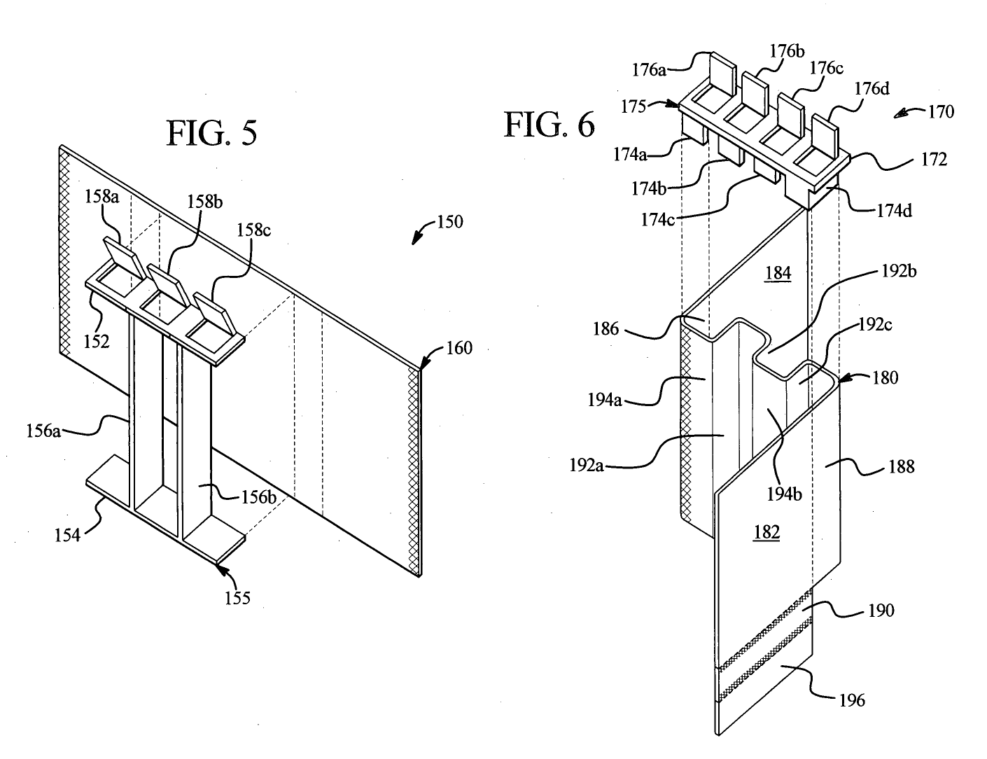

Referring now to FIG. 5, an alternative embodiment for the dispenser of the present invention is illustrated by dispenser 150. Dispenser 150 includes two primary components, an inner plastic frame 155 and a shell or cover 160. Inner plastic frame 155 includes a top portion 152, a bottom portion 154 and separating walls 156a and 156b. In one embodiment, top portion 152, bottom portion 154 and separating walls 156a and 156b are made of plastic and can be made of a single piece or multiple pieces of plastic. Although not illustrated, plastic frame 155 can include one or more flange that extends (i) downward from top 152, (ii) upward from bottom 154 or (iii) outwardly or inwardly from separating walls 156a and 156b.

Top portion 152 includes or defines lids 158a to 158c. Lids 158a to 158c in one embodiment are attached hingedly to top portion 152. In an embodiment, lids 158a to 158c snap-fit to the frame of upper portion 152. Again, lids 158a and 158c can be hingedly connected to the same or different sides of upper portion 152. Cover 160 folds about frame 155 along the dotted lines shown on cover 160. In one embodiment, cover 160 is adhered to any one or more or all of top portion 152, bottom portion 154 and separating walls 156a and 156b. The cover 160 in combination with frame 155 defines three separate compartments into which different types, shapes and colors of confectionery products are stored and from which they are retrieved.

It should be appreciated that dispenser 150 includes plastic separating walls 156a and 156b as opposed to the paperboard separating walls in previous embodiments. The plastic frame 155 includes or defines press-fitting apparatuses, such as grooves, in one embodiment, that press-fit edges or folds of cover 160.

Referring now to FIG. 6, a further alternative embodiment of the confectionery product, package or dispenser of the present invention is illustrated by dispenser 170. FIG. 5 illustrated an alternative embodiment where the separating walls 156a and 156b are made of plastic. Dispenser 170 of FIG. 6 alternatively illustrates an embodiment where the housing 180, which includes a front wall 182, a rear wall 184, sides 186 and 188 as well as a bottom 190. In FIG. 6, housing 180 is shown in the flat except that it is bent to illustrate that the single paperboard piece forms separating walls 192a, 192b and 192c. Separating walls 192a to 192c form four separate compartments when front 182, back 184 and bottom 190 are bent to enclose the compartments on three sides.

A plastic top 175 is attached via adhesive and/or a pressure fit to enclose the formed housing 180. Alternatively, top 175 is affixed to housing 180 at some intermediate state of the formation of housing 180, for example, at the state of bending shown in FIG. 6.

Top 175 includes a frame portion 172 and flange portions 174a to 174d. As illustrated, flange portions 174a and 174c are inset slightly to be received behind front faces 194a and 194b. The fronts of flange portions 174b and 174d of top 170 on the other hand are flush with the front of frame 172 so as to be able to mate with the back side of front 182 of housing 180. The sides of flange portions 174b and 174d that abut sides 186 and 188 of housing 180, respectively, are inset however to be disposed behind the sidewalls.

Suitable adhesive may be applied to top 170 and/or upper portions of paperboard housing 180 to secure the two pieces. Bottom 190 is bent upward to adhere or press-fit to the serpentine-like shape of front faces 194a and 194b and separating walls 192a to 192c. An additional flange 196 is provided to adhere or press-fit to either the inside surface or outside surface of back 184 to provide for a more secure attachment of bottom 190 to the remainder of housing 180. It should be appreciated that in an alternative embodiment, a plastic bottom similar in shape to plastic top 170 is press-fit or adhered to housing 180 in lieu of bottom 190 and rear flange 196.

Top 170 includes four doors or lids 176a to 176d. Doors or lids 176a to 176d are connected hingedly to frame 172. Any of the alternative configurations described above for hingedly connecting such doors to frame 172 are applicable in connection with package or dispenser 170. The plastic and paperboard pieces are made of any of the materials described above in the previous embodiments. While each of the embodiments described herein shows the doors connected to the respective package tops, any of the embodiments can alternatively have the doors connect hingedly to the respective housings, e.g., to the front, back or sides of the housings.

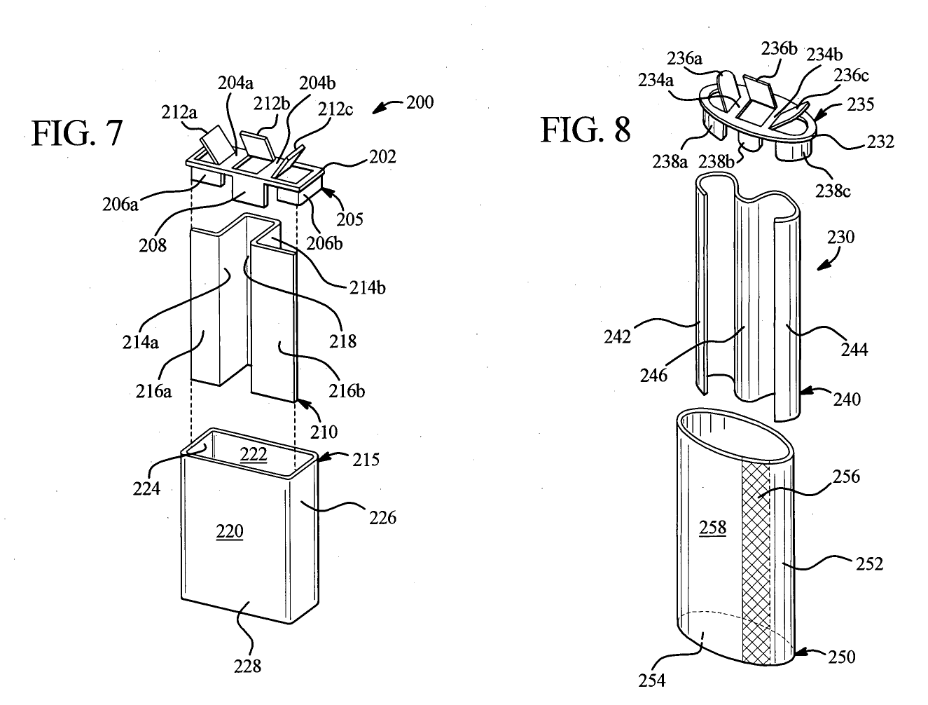

Referring now to FIG. 7, a further alternative embodiment of the package or dispenser of the present invention is illustrated by dispenser 200. Dispenser 200 includes a plastic top, a paper insert 210 and a paperboard housing 215. Housing 215 includes a front 220, a back 222, sides 224 and 226 and a bottom 228. Housing 215 is made of paperboard and is folded together to produce the illustrated shape and is adhered or press-fit together. Insert 210 is a folded piece of paperboard, which is folded from a flat piece to form two front faces 216a and 216b, separating walls 214a and 214b and a back face 218. Insert 210 is folded to have a shape and size that fits snugly within housing 215. Insert 210 may or may not be adhered to housing 215. Insert 210 it should be appreciated may be folded differently than as shown and still provide a desired number of compartments via alternative separating walls 214 (referring collectively to 214a, 214b, etc.) as well as alternative front facing walls 216 (referring collectively to walls 216a and 216b) and rear face 218.

Top 205 includes three doors or lids 212a to 212c. The lids as illustrated open in different directions and provide a unique dispenser that enables the consumer to orient dispenser 200 in different directions to dispense different types, colors or flavors, etc., of confectionery products. For example, the consumer tips dispenser 200 frontward to dispense product from the middle compartment enclosed by door 212b. The consumer alternatively tips dispenser 200 towards one of the sides 224 and 226 to dispense products from the compartments enclosed by door 212a or door 212c, respectively.

As illustrated, middle door 212b is hingedly connected to an outer portion of frame 202, while outer doors 212a and 212c are hinged to dividers 204a and 204b, respectively. In an alternative embodiment, outer doors 212a and 212c could be hinged to the outer side portions of frame 202 or to any of the hingeable sides of the accessways to enclose the compartments of dispenser 200.

As illustrated, top 205 includes recessed flanges 206a and 206b that are disposed eventually behind front faces 216a and 216b, respectively, of insert 210. An adhesive or press-fit is made between flanges 206a and 206b and faces 216a and 216b of insert 210. Flanges 206a and 206b can also be adhered or press-fit to back 222 of housing 220. Further, a flush flange 208 of top 205 can be press-fit or adhered to front 220 of housing 215. As illustrated, bottom 228 of housing 215 is made of paperboard.

Referring now to FIG. 8, a farther alternative embodiment of the package or dispenser of the present invention is illustrated by dispenser 230. Dispenser 230 includes the same basic components as dispenser 200, namely, a plastic top 235, a paperboard insert 240 and a paperboard housing 250. Dispenser 230 illustrates that in any of the configurations of the present invention, the dispenser can be rectangular, rounded or ovular or have any suitable combination thereof.

Housing 250 includes an outer shell 252 and a bottom 254. The shell wraps around itself and is secured in an embodiment via adhesive 256. The bottom 254 is also folded together to produce its desired shape and is secured adhesively in one embodiment. Housing 250 defines an open top aperture. Insert 240 is fitted snugly into housing 250. Insert 240 includes outer bends 242 and 244 that mate with the curved sides of shell 252 of housing 250. Insert 240 also includes an inner bend 246 that mates with a front face 258 of housing 250. Bends 242, 244 and 246 can be adhesively connected to shell 252 in places where contact is made between insert 240 and housing 250.

Top 235 includes a border 232 and dividers 234a and 234b that collectively define three accessways, which are aligned with three compartments made by insert 240. The accessways are enclosed by doors or lids 236a, 236b and 236c, respectively. Doors or lids 236a to 236c open in different directions as discussed above in connection with dispenser 200 and FIG. 7. As with the other doors or lids of the present invention, the top 235 is provided with suitable snap-fitting apparatus which can removably lock doors 236a to 236c in place until the consumer desires to dispense a product from one of the compartments.

Top 235 includes or defines flanges 238a to 238c that in one embodiment are inset to fit behind insert 240 and configured to help press-fit insert 240 against the inner surface of shell 252 of housing 250. A suitable adhesive may also be employed to either adhere insert 240 to the inside of housing 250, adhere flanges 238a to 238c to the insert 240 or both. In an alternative embodiment, flanges 238a to 238c of top 235 are located to fit between insert 240 and wrapper 252 of housing 250.

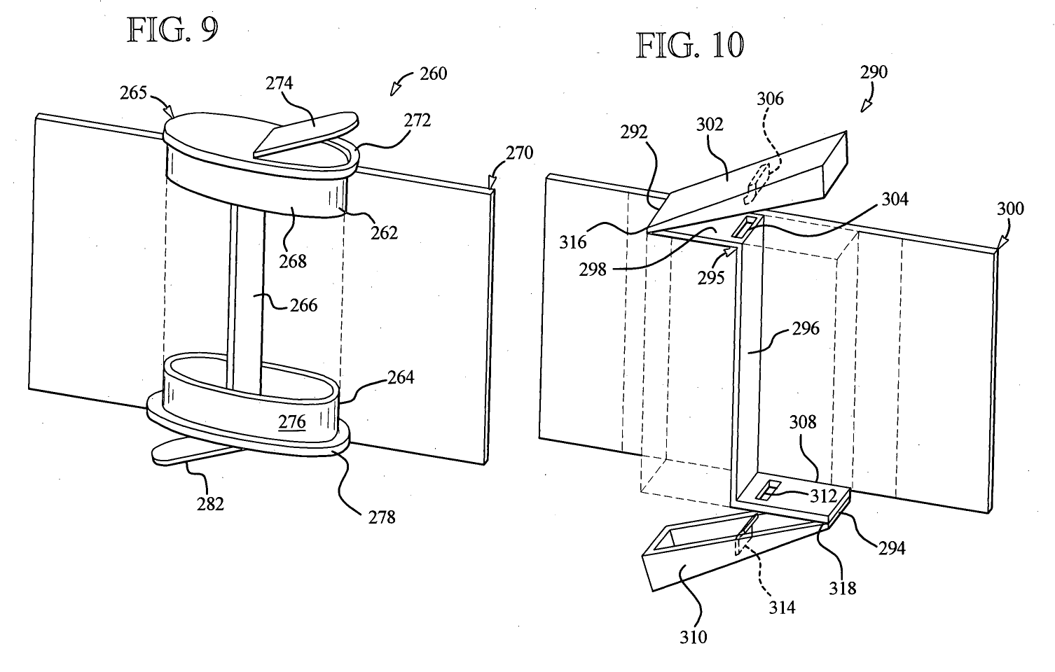

Referring now to FIG. 9, yet another alternative embodiment for the dispenser of the present invention is illustrated by dispenser 260. Dispenser 260 includes two primary components, an inner plastic frame 265 and a shell or cover 270. Inner plastic frame 265 includes a top portion 262, a bottom portion 264 and a separating wall 266. In one embodiment, top portion 262, bottom portion 264 and separating wall 266 are made of plastic and can be made of a single piece or multiple pieces of plastic.

As illustrated, plastic frame 265 includes a flange 268 that extends downward from a lid 272 of the top portion 262. A flange 276 extends upward from a floor 278 of the bottom portion 264 of frame 265. Shell or cover 270, which in one embodiment is paperboard, wraps around flanges 268 and 276. In one embodiment, cover 270 is adhered to flanges 268 and 276 and/or lid 272 or floor 278. Cover 270 can also be press-fitted between lid 272 or floor 278, which are spaced apart a set distance via separating wall 266.

Top portion 262 of frame 265 includes or defines a door 274. Door 274 in one embodiment is attached hingedly to lid 272. In an embodiment, door 274 snap-fits to the lid 272 of top portion 262. Bottom portion 264 of frame 265 includes or defines a door 282. Door 282 in one embodiment is attached hingedly to floor 278. In an embodiment, door 282 snap-fits to the floor 278 of bottom portion 264. Doors 274 and 282 allow access to separate compartments defined by frame 265 (including separating wall 266) and cover 270.

Doors 274 and 282 as illustrated can each be hingedly connected to the center portion of lid 272 and floor 278, respectively, or one or both may be hinged to an outer edge of lid 272 and floor 278, respectively, and open inwardly. Dispenser 260 is shown including a plastic separating wall 266. In an alternative embodiment, a paperboard separating wall may be provided as shown in previous embodiments. Similarly, any of the previous embodiments may have doors or lids that open on different or opposite surfaces of the respective dispenser.

Doors 274 and 282 allow selective access to different product holding compartments, which can hold the same or different types of confectionary products as described herein. Third and forth compartments, etc., may be provided, wherein any suitable part of frame 265 or cover 270 provides third and forth accesses, respectively, to allow selective access to the third and fourth compartments. Further, either one or both doors 274 and 282 may be placed alternatively on cover 270. Dispenser 260 may be angled (e.g. rectangular) or rounded (as shown).

Referring now to FIG. 10, still a further alternative embodiment for the dispenser of the present invention is illustrated by dispenser 290. Dispenser 290 includes two primary components, an inner plastic frame 295 and a shell or cover 300. Inner plastic frame 295 includes a top portion 292, a bottom portion 294 and a separating wall 296. In one embodiment, top portion 292, bottom portion 294 and separating wall 296 are made of plastic and can be made of a single piece or multiple pieces of plastic.

As illustrated, top portion 292 includes a base 298 and a door or lid 302 that connects hingedly to base 298. Base 298 extends outwardly from separating wall 296 and can be formed integrally with separating wall 296 or be attached to separating wall 296. Base 298 defines an aperture 304. Mating lid 302 defines a lip 306 that snap-fits into aperture 304 of base 298. Mating lid 302 also includes side walls that extend about the outside of cover 300. As seen at point 316 of lid 302, the lid extends further out in both directions from a center of base 298 than does the base 298 itself. Such overhang on both sides of base 298 enables cover 300 to fit snugly between lid 302 and base 298.

Likewise, bottom portion 294 includes a base 308 and a door or lid 310 that connects hingedly to base 308. Base 308 extends outwardly from separating wall 296 (in the opposite direction from base 298) and can be formed integrally with separating wall 296 or be attached to separating wall 296. Base 308 defines an aperture 312. Mating lid 310 defines a lip 314 that snap-fits into aperture 312 of base 308. Mating lid 310 also includes side walls that extend about the outside of cover 300. As seen at point 318 of base 308, lid 310 extends further out in both directions from a center of base 308 than does the base 308 itself. Such overhang on both sides of base 308 enables cover 300 to fit snugly between lid 310 and base 308.

Shell or cover 300, which in one embodiment is paperboard, wraps around separating wall 296 and bases 298 and 308. In one embodiment, cover 300 is adhered to wall 296 and bases 298 and 308. Cover 300 can also be adhered to itself when wrapped about frame 295. Cover 300 folds about frame 295 along the dotted lines shown on cover 300. The cover 300 in combination with frame 295 defines two separate compartments into which different types, shapes and colors of confectionery products are stored and from which they are selectively retrieved.

Doors or lids 302 and 310 allow access to separate compartments defined by frame 295 (including separating wall 296) and cover 300. Dispenser 260 is shown including a plastic separating wall 296. In an alternative embodiment, a paperboard separating wall may be provided as shown in previous embodiments. Third and forth compartments, etc., may be provided, wherein any suitable part of cover 300 provides third and forth accesses, respectively, to allow selective access to the third and fourth compartments. Dispenser 290 may be rounded or angled (as shown).

Any of the dispensers described herein, may be wrapped in an outer wrapper or foil and include any suitable number of tamper-resist strips.

It should be understood that various changes and modifications to the presently preferred embodiments described herein will be apparent to those skilled in the art. Such changes and modifications may be made without departing from the spirit and scope of the present invention and without diminishing its attendant advantages.

The invention is claimed as follows:

1. A confectionery product package comprising:
a paperboard housing that includes a front, a back, two sides and a bottom;
at least one separating wall placed inside the housing to divide the housing into at least two compartments, the compartments capable of holding separate quantities of confectionary products;
a formed plastic top attached to at least one of the front, back, sides and separating wall, the top holding the confectionary products inside of the housing; and
wherein at least one of the front, back, sides and top provides an access to the products.

2. The confectionary product package of claim 1, wherein the top provides the access to each of the confectionary products.

3. The confectionary product package of claim 1, which includes a separate access to each confectionary product.

4. The confectionary product package of claim 3, wherein each access is protected by a separate tamper proof seal.

5. The confectionary product package of claim 1, wherein the access includes at least one hinged door.

6. The confectionary product package of claim 1, wherein the separating wall is formed integrally with at least one of the front, back, sides and bottom.

7. The confectionary product package of claim 1, wherein the separating wall is an insert separate from the front, back, sides and bottom.

8. The confectionary product package of claim 1, wherein the front, back and sides are interfaced with each other at angles or in a rounded manner.

9. The confectionary product package of claim 1, wherein the plastic top is attached to the housing via a friction fit, an adhesive or both.

10. The confectionary product packaging of claim 1, wherein the plastic top includes sides that extend into the housing and engage at least one of the front, back and sides.

11. A confectionary product package comprising:
a paperboard housing that includes a front, a back and two sides;
at least on separating wall placed inside the housing to divide the housing into at least two compartments, the compartments capable of holding separate quantities of confectionary products;
a formed plastic top attached to at least one of the front, back, sides and separating wall;
a formed plastic bottom attached to at least one of the front, back, sides and separating wall, the top and bottom holding the confectionary products inside the housing; and
wherein at least one of the front, back, sides, top and bottom provides an access to the confectionary products.

12. The confectionary product package of claim 11, wherein the plastic top and plastic bottom are attached to the housing via a friction fit, an adhesive or both.

13. The confectionary product package of claim 11, wherein the plastic top and the plastic bottom and substantially identical and the access is provide by at least one of the front, back and sides.

14. The confectionary product package of claim 11, wherein the plastic top and plastic bottom are substantially identical except that the access is provided by the top via at least one hinged door.

15. The confectionary product package of claim 11, wherein the plastic top provides a first access to a first one of the compartments and the plastic bottom provides a second access to a second one of the compartments.

16. The confectionary product package of claim 15, wherein the first access and the second access each include a hinged door, the hinged doors opening (i) in a same direction or (ii) in different directions.

17. The confectionary product package of claim 11, wherein the plastic top and plastic bottom are connected to form a single piece.

18. The confectionary product package of claim 11, wherein the separating wall is plastic and is connected to the plastic top and plastic bottom.

19. The confectionary product package of claim 11, wherein at least one of the plastic top and plastic bottom is translucent/transparent to view the confectionary products.

20. A confectionary product package comprising:
a closed volume including a top, bottom, front, back and sides;
a plastic frame including (i) at least one of the top and bottom and (ii) at least one separating wall;
a paperboard cover disposed about the plastic frame and forming with the frame the closed volume, which is separated into at least two compartments by the separating wall, the compartments capable of holding separate quantities of confectionary products; and
an access to the confectionary products provided by at least one of the plastic frame and paperboard cover.

21. The confectionary product package of claim 20, wherein the plastic frame forms the top and the bottom and the paperboard cover forms the front, back and sides of the closed volume.

22. The confectionary product package of claim 20, wherein the plastic frame forms the top and the paperboard cover forms the front, back, sides and bottom of the closed volume.

23. The confectionary product package of claim 20, wherein the plastic frame forms the bottom and the paperboard cover forms the front, back, sides and top of the closed loop.

24. The confectionary product package of claim 20, wherein the plastic frame forms the top and the bottom, and wherein (i) the top provides a first access to a first one of the compartments and (ii) the bottom provides a second access to a second one of the compartments.

25. The confectionary product package of claim 24, wherein the first access and the second access each include a hinged door, the hinged doors opening (i) in a same direction or (ii) in different directions.

26. A confectionary product dispensing method comprising the steps of:
enabling a consumer to open a first container compartment and remove a first confectionary product held separately in the first compartment;
enabling the consumer to close the first container compartment and open a second container compartment and remove a second confectionary product held separately in the second compartment; and
enabling the consumer to close the second container compartment and store the container for future use.

27. The confectionary product dispensing method of claim 26, which includes enabling the consumer to select a confectionary product of a desired type, shape, size, color, texture, flavor and any combination thereof.

28. The confectionary product dispensing method of claim 26, which includes enabling the consumer to consume one of the products while maintaining another product in a sealed, unopened state.

29. The confectionary product dispensing method of claim 26, which includes enabling the consumer to mix the first and second confectionary products to consume a desired mixture of the products.
